(19) United States
(12) Patent Application Publication
(10) Pub. No.: US 2022/0322606 A1
(43) Pub. Date: Oct. 13, 2022

(54) RAKE MOUNTABLE TO A FRONT END LOADER

(71) Applicant: Robert Rhodes, Spencer, WV (US)

(72) Inventor: Robert Rhodes, Spencer, WV (US)

(21) Appl. No.: 17/224,457

(22) Filed: Apr. 7, 2021

(51) Int. Cl. A01D 78/00; E02F 3/96; A01D 78/14

(52) U.S. Cl. CPC A01D 78/001; E02F 3/96; A01D 78/14

(57) ABSTRACT

A rake having tine wheels has a coupler configured to attach to the front end loader of a vehicle, such as a tractor. The rake has a series a tine wheels and support elements extend generally forward and outward from the coupler with the tine wheels overlapping to move vegetation toward the center of the rake. The tine wheels and support elements are rotatably mounted around substantially horizontal axes directed generally in the direction of travel for the rake which allows the rake to adapt to terrain. The support elements may also rotate around additional axes that allow the support elements to raise and lower. Some embodiments of the rake have trailing arms with wheels to support the rake while deployed for use. These wheels trail the rake and keep the turning radius nearly the same as the vehicle.

### FIELD OF INVENTION

The present application is generally related to a rake, such as a hay rake. More specifically, the present application relates to a rake mounted on a front end loader of a tractor or of other similar vehicle.

### BACKGROUND OF THE INVENTION

The various livestock in agriculture require feed. For some livestock the feed is produced and stored by cutting various vegetation such as hay and alfalfa and processing the cut vegetation into bales. The bales are stored to feed to livestock over time. Frequently, the feedstock is cut and left to dry on the ground. Once, the feedstock is sufficiently dried, it is raked into rows in preparation for baling. A baler is then used to compress the feedstock into bales. The several pieces of equipment, i.e. mower, rake, and baler, are typically carried or towed by a tractor or other vehicle.

Various approaches are taken to improve the efficiency of the process. Among these are combining the raking step and the baling step. This can be accomplished by towing a baler behind the tractor, while operating a rake forward of the baler such as at the front of the tractor, between the front and back wheels of the tractor, or between the tractor and the baler. The rake and the baler are arranged so that the rake aligns the rows with the intake of the baler. This arrangement may create a long train of equipment that is difficult to maneuver. In some fields, entering and exiting a field with a rake and baler in alignment may be impractical with previously available rakes. Additionally, if the rake is not towed or carried by the standard three- point-hitch at the rear of the tractor, additional hitches or mounts may be needed to transport the rake.

In some cases, it is not a matter of improving efficiency by combining processes. Rather it may be a challenge to get a rake to operate efficiently by itself. For example, small or oddly shaped fields make it difficult for a towed rake to operate in alcoves or very tight turns. Rough terrain in or around fields may require a rake to be lifted, which is something that can't be done with a towed rake, and lift is limited if a three point hitch is used.

### RELEVANT ART

U.S. Pat. No. 8,495,856 by Collins is for “FRONT MOUNTED ROTARY HAY RAKE”. In Collins, a rotary type rake has a plurality of finger wheel rotary raking elements mounted on a frame and movable thereon from one to the other of a raking position to rake material on the ground into a windrow and a retracted raised traveling position. The frame is partly supported by a pair of caster wheel assemblies that are disposed in spaced apart relation with respect to one another at a distal end of the frame which connects securely to a front end loader mounted on a tractor. Oscillatory movement of the caster wheel assemblies is restrained by a brake acting on the shaft of the caster wheel assembly by which it is mounted on the frame.

U.S. Pat. No. 4,753,063 by Buck is for “HAY RAKING IMPLEMENT”. An implement for raking hay which can be quickly mounted on either a wide front wheel vehicle or a narrow front wheel vehicle. The hay raking implement can be quickly adjusted between a front operating position or a side operating position for a particular raking operation.

U.S. Pat. No. 5,987,864 by Lutz is for “FRONT MOUNTED RAKE”. In Lutz, a front mounted rake includes a primary support, a first arm and a second arm. Tine wheels are mounted on each of the arms. The first end of each arm is secured for pivotal movement about both a substantially vertical axis and about a substantially horizontal axis to the primary support. The second end of each arm is supported by ground engaging wheels. A brace maintains the relative lateral spacing of the arms. The pivotal movement of the second arm about the substantially horizontal axis is independent of the pivotal movement of the first arm about the substantially horizontal axis thereby permitting the first arm and the second arm to independently raise and lower as the ground engaging wheels travel over ground contours.

U.S. Pat. No. 4,214,428 by Caraway is for “RAKING AND BALING MACHINE”. In Caraway, a pair of multiwheel divergent rakes are coupled to the front end of a wide wheel farm tractor. The two rakes produce a single five foot wide windrow of hay or grain over which the tractor can pass. A conventional round baler towed by the same tractor produces round bales which are deposited in the field behind the machine. This eliminates the necessity for separate raking and baling passes utilizing separate tractors. The front-mounted rakes can be hoisted and folded to facilitate roadway transport.

As may been seen by reviewing the relevant art, there remains a need for a rake that can be easily mounted to a tractor having a front end loader and that can easily be lifted over obstacles or rough ground by the front end loader. Additionally, there remains a need for a rake that maintains its own operational height while still allowing the tractor to maintain its tight turning radius.

### SUMMARY OF EMBODIMENTS OF THE INVENTION

Embodiments of the present rake comprise a coupler for attaching to a front end loader on a vehicle such as a tractor. The coupler has a back facing toward the vehicle and a front face away from the vehicle. A set of supports extend to each side of the coupler and forward. The tine wheels rotatably mount to the supports. The tine wheels furthest out from the coupler are the furthest forward with each successive tine wheel being stepped back and overlapping its neighboring tine wheel until a final gap left in the center of the coupler. Rotation is induced in the tine wheels by the movement of the rake along the ground by its carrying vehicle. The rotating tine wheels pass loose vegetation to the gap and form rows.

The tine wheels and their supports suspend from the coupler and the entire apparatus may be lifted and lowered by the front end loader. In that way the apparatus can be lifted to avoid obstacles, rough terrain, etc. and then easily lowered to be deployed for use. When the rake is in a deployed position, the rotatable connections between the various supports and between the supports and the tine wheels rotate about substantially horizontal axes directed forward from the coupler. The axes need not be precisely horizontal, but only sufficiently so such that the apparatus can adjust as it traverses the ground while maintaining resilience along its width. The supports may also rotate about other axes to provide additional flexibility of the apparatus. For example, incorporating a rotating joint with an axis transverse to the forward direction but also substantially horizontal allows full sets of supports and tine wheels to adjust together to the terrain.

Some embodiments of the rake will also have wheels supported by trail arms extending back from the coupler. These wheels support the rake and maintain it at a consistent height over the terrain. Being behind the coupler, the wheels are closer to the wheels of the carrying vehicle which allows the vehicle to maintain its normal turning radius. Some embodiments of the rake incorporate a rotating joint between the trail arms and the coupler to allow the wheels to vary their track as the carrying vehicle turns and steers. Since these wheels are pulled by the coupler, the castor action of the wheels is smoother and shaking motion is not produced in the rake beyond that due to rough terrain.

### BRIEF DESCRIPTION OF DRAWINGS

Additional utility and features of the invention will become more fully apparent to those skilled in the art by reference to the following drawings, which illustrate some of the primary features of preferred embodiments.

FIG. 1 is a side perspective view of an embodiment of a rake of the present invention attached to a front end loader.

FIG. 2 is a side perspective view of an embodiment of a rake detached from a front end loader, showing where the rake connects to the front end loader.

FIG. 3 is a front view of an embodiment of a rake of the current invention.

FIG. 4 is a rear perspective view of an embodiment of a rake of the current invention, showing banks of supports for tine wheels.

FIG. 5 is a front perspective view of a rake coupler out to the base of the supports for the tine wheels.

FIG. 6 is a side perspective view of an embodiment of a rake of the present invention attached to a front end loader and lifted off its wheels.

FIG. 7 is a front perspective view of an embodiment of a rake attached to a front end loader and with its tine wheels and their supports in an up position for transport.

### DETAILED DESCRIPTION OF EMBODIMENTS OF THE INVENTION

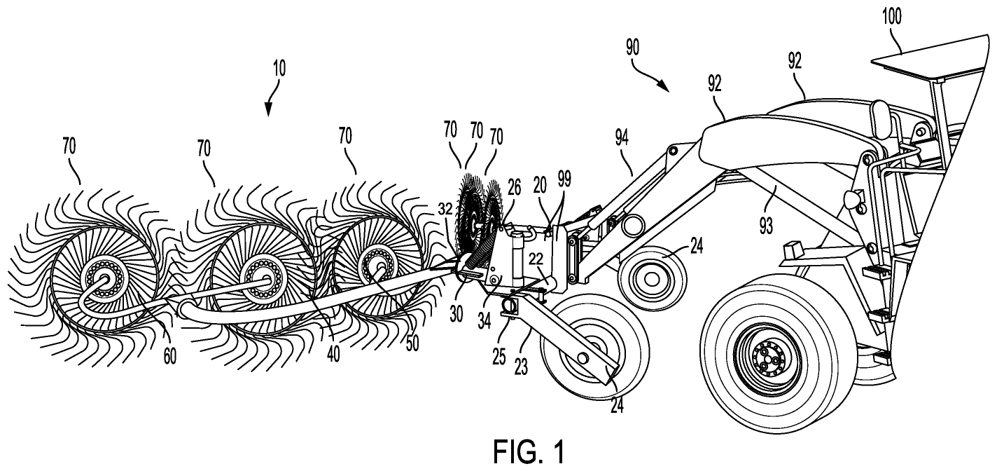

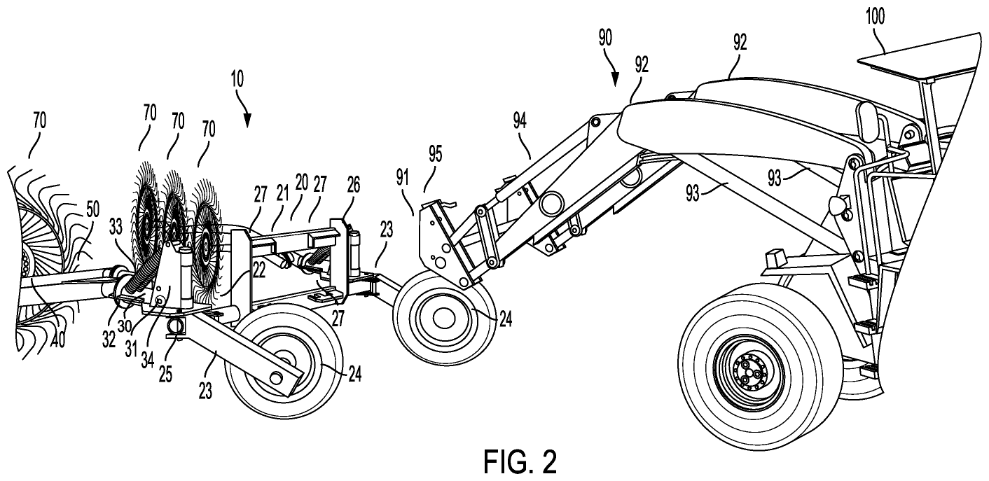

FIG. 1 is a side perspective view of an embodiment of a rake 10 of the present invention attached to a front end loader 90. FIG. 2 is a side perspective view of an embodiment of a rake 10 detached from a front end loader 90, showing where rake 10 connects to front end loader 90. Rake 10 incorporates coupler 20. Implement receiver 91 is mounted on front end loader 90. Coupler 20 and receiver 91 form a connector 99 between rake 10 and front end loader 90. Coupler 20 and connector receiver 91 have respective complementary connecting elements 27 and 95 that allow them to join each other to form connector 99. There are a wide variety of connectors for mounting an implement to a front end loader, or similar manipulator, and the present invention is not limited to a specific connector. Coupler 20 has a back 21 facing back toward the front end loader 90 of a vehicle, and a front facing forward away from the vehicle. Receiver 91 spans between, and connects, lift arms 92 of front end loader 90. Receiver 91 has a front facing away from the vehicle. In FIGS. 1 and 2, coupler 20 comprises, in general, a rectangular frame with connecting elements 27 compatible with connecting elements 95 on receiver 91 for connecting coupler 20 to receiver 91. Lift cylinders 93 of front end loader 90 raise and lower lift arms 92 and, thereby, rake 10. Control cylinders 94 control the angular relationship of receiver 91 of implement connector 99 with lift arms 92 and thereby control the angle at which front end loader 90 carries rake 10. As previously stated, any implement connector between rake 10 and front end loader 90 may be used with a portion of the connector being incorporated into a given embodiment of rake 10.

In the embodiments of FIG. 1 and FIG. 2, cross beam 22 is mounted to coupler 20 and provides the frame for mounting other elements of rake 10. Boom mounts 30 are connected to boom brackets 34 at rotary joints 31 and extend forward from cross beam 22. Boom brackets 34 rotate about masts 26 connected to cross beam 22 or coupler 20. A boom 40 is rotatably connected to each boom mount 30 at rotary joints 32. At least one tine wheel 70 is rotatably mounted, directly or indirectly, on each of booms 40. When rake 10 is installed on a front end loader 90 and deployed for use, booms 40, support arms 50, and spars 60 are rotatable around substantially horizontal axes and tine wheels 70 are rotatable around substantially horizontal axes on booms 40, support arms 50, and spars 60. This allows tine wheels 70 and their supports to float along the ground as rake 10 is move along the ground. Tine wheels 70 are mounted at a slight angle from perpendicular with the direction of travel of rake 10. Alternatively stated, the axes of tine wheels 70 deviate slightly from parallel to the direction of travel of rake 10 while being substantially horizontal. This causes tine wheels 70 to acquire rotation from their interaction with the ground and plants growing from the ground as rake 10 is moved in the forward direction by its associated vehicle, tractor 100.

Trail arms 23 extend backward from coupler 20 and cross beam 22. Wheels 24 mounted to trail arms 23 maintain tine wheels 70 of rake 10 at an appropriate height when rake 10 is deployed for use. In some embodiments of rake 10, trail arms 23 will be connected to coupler 20 or cross beam 22 with rotary joints, such as castor joints 25, having axes of rotation being substantially vertical when rake 10 is deployed for use and wheels 24 are in contact with the ground. This allows trail arms 23 to adjust as the carrying vehicle, tractor 100, turns. In some embodiments, trail arms 23 may be adjustable to adjust the operating height of rake 10.

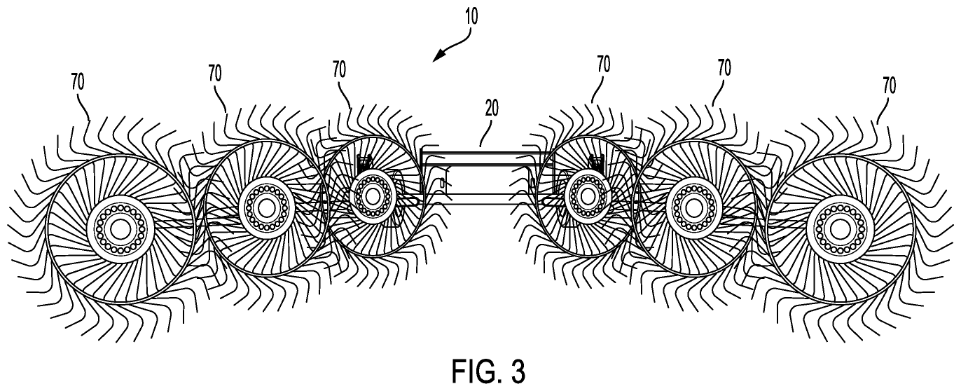

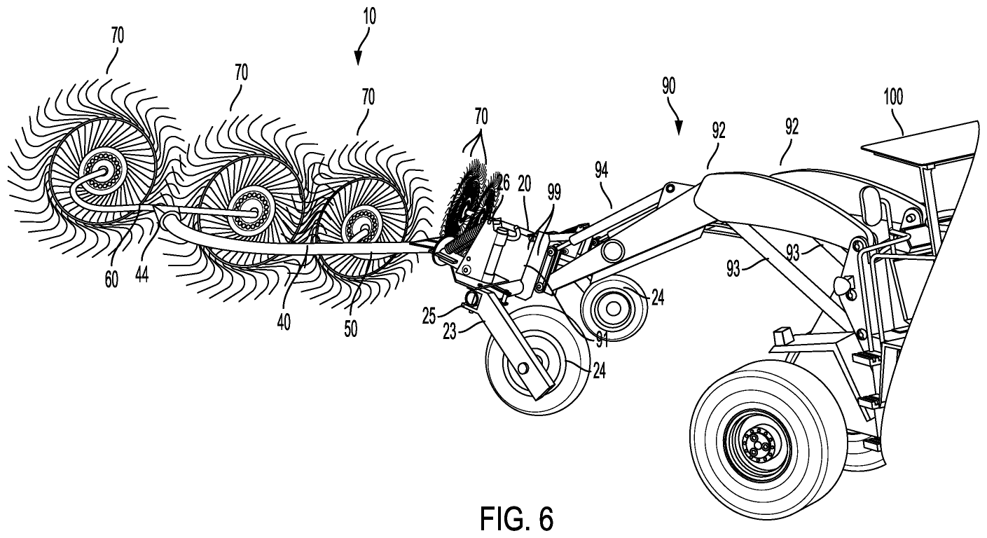

FIG. 3 is a front view of an embodiment of rake 10 of the current invention. The embodiment shown in FIG. 3 has 6 total tine wheels 70 with 3 tine wheels 70 per side. The tine wheels 70 slightly overlap each other with the outer tine wheels 70 being slightly in front of their inner neighbor. The rotation of tine wheels 70 moves the material toward the center where a gap is left in the tine wheels 70 to produce a row of raked material. Although the embodiment shown in FIG. 6 comprises 6 tine wheels 70, other embodiments may incorporate more or fewer tine wheels 70, and the configuration of booms 40 and support arms 50 may be altered accordingly. It is not even a requirement that rake 10 be symmetrical about its center.

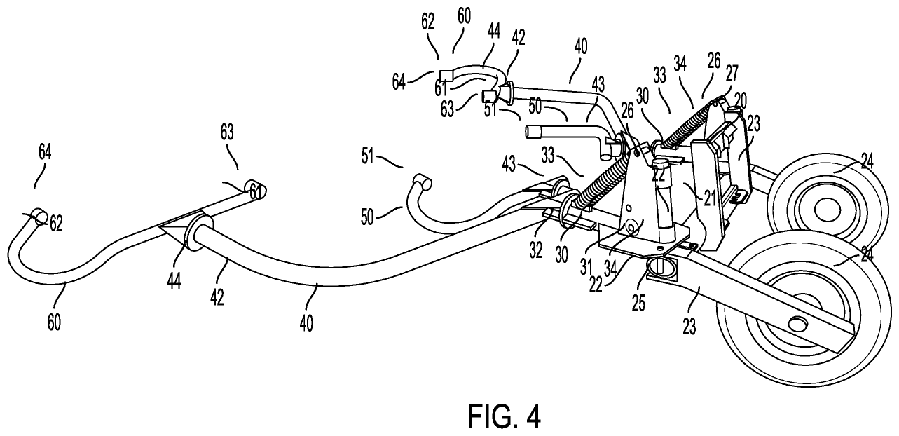

FIG. 4 is a rear perspective view of an embodiment of rake 10 of the current invention, showing two banks of supports without tine wheels 70. In FIG. 4, the supports include booms 40, support arms 50 and spars 60. FIG. 1 shows a similar view but with tine wheels 70 in place. Boom mount 30 extends forward from coupler 20 and defines a substantially horizontal axis when rake 10 is deployed. Boom 40 has two ends, a proximal end 41 and a distal end 42, and is rotatably mounted between its two ends to boom mount 30 to rotate about the axis of boom mount 30. Proximal end 41 of boom 40 is closer to boom mount 30 and extends toward the center of rake 10. Support arm 50 is rotatably connected to boom 40 proximal to proximal end 41 of boom 40 at rotary joint 43. Support arm 50 has rotary joint 51 by which tine wheel 70 is rotatably mounted to support arm 50. Both support arm 50 and tine wheel 70 are rotatable about substantially horizontal axes when rake 10 is deployed for use. Opposite to its proximal end 41, boom 40 extends outward away from boom mount 30 and curves forward to place its distal end 42 forward of tine wheel 70 on support arm 50. Distal end 42 of boom 40 terminates in a rotary joint 44 defining a substantially horizontal axis when rake 10 is deployed for use. Spar 60 has a proximal end 61 and a distal end 62 and is rotatably connected between its proximal and distal ends, 61 and 62, to boom 40 at rotary joint 44 on distal end 42 of boom 40. Proximal end 61 of spar 60 extends toward the center of rake 10 and forward of tine wheel 70 on support arm 50. Rotary joint 63 on spar 60 is proximal to proximal end 61 of spar 60 and defines a substantially horizontal axis when rake 10 is deployed for use. Tine wheel 70 rotatably mounts to rotary joint 63. Tine wheel 70 on rotary joint 63 is forward of tine wheel 70 on rotary joint 51 and the two tine wheels 70 overlap slightly. Distal end 62 of spar 60 extends outward away from the center of rake 10 and forward of tine wheel 70 on proximal end 61 of spar 60. Rotary joint 64 on spar 60 is proximal to distal end 62 of spar 60 and defines a substantially horizontal axis when rake 10 is deployed for use. Tine wheel 70 rotatably mounts to rotary joint 64. Tine wheel 70 near distal end 62 of spar 60 is forward of tine wheel 70 near proximal end 61 of spar 60 and tine wheels 70 slightly overlap. A similar set of boom mount 30, boom 40, support arm 50, spar 60 and tine wheels 70, all interconnected by rotatable joints, are located on the other side of coupler 20.

With the arrangement of support elements and tine wheels 70 described and shown in FIG. 4, the tine wheels in each set overlap each other with the outer tine wheels being forward. As rake 10 is moved along the ground, rotation is imparted to the tine wheels such that the bottom edge of the tine wheels are moving toward the center of rake 10. This motion of the tine wheels moves loose vegetation toward the center of rake 10, passing from one tine wheel to the next, until the vegetation is deposited in the center of the rake.

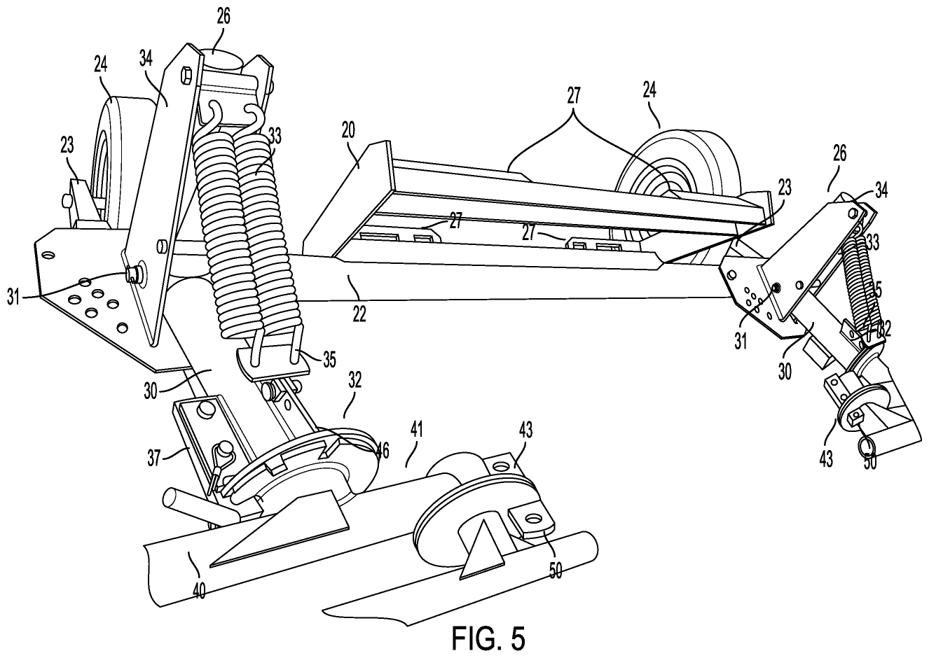

FIG. 5 is a front perspective view of a rake coupler 10 out to the base of the supports for the tine wheels. Cross beam 22 runs across the front of coupler 20. Masts 26 extend upward from approximately the ends of cross beam 22. Boom brackets 34 rotate about masts 26. When rake 10 is deployed for use, boom brackets 34 rotate about a substantially vertical axis. Boom mounts 30 connect to boom brackets 34 at rotary joints 31 which have a substantially horizontal axis when rake 10 is deployed for use. Booms 40 connect to boom mounts 30 at rotary joints 32. When rake 10 is deployed for use rotary joints 32 have substantially horizontal axes. The axes of rotary joints 31 and 32 may, or may not, intersect. They may be offset, or be skewed from each other, i.e. lie in different substantially horizontal planes, when rake 10 is deployed for use.

Rake 10 may have various adjustable elements and some are shown in FIG. 5 with respect to boom brackets 34, boom mounts 30, and rotary joints 32. Springs 33 connect between boom brackets 34 and boom mounts 30. Spring brackets 35 can be adjusted to provide desired support of boom mounts 30 of the extended ends of boom mounts 30 to generally support and suspend the bank of elements on a respective side. The balance of support not provided by springs 33 is derived by interaction of the tine wheels with the ground such that a bank of tine wheels and their supports “float” along the ground. Notched flanges 45 at rotary joints 32 are fixed to booms 40 and rotate with booms 40. Fixed flanges 36 at rotary joints 32 are fixed to boom mounts 30. Stops 37 (only visible on left) on boom mounts 30 may be engaged with different notches 46 on notched flanges 45 to hold booms 40 in fixed orientation while support arms 50 and spars 60 adjust freely, or stops 37 may be disengaged to allow booms 40 to also adjust freely about rotary joint 32. Stops 37 and notches 46 may be used to maintain booms 40 in an essentially vertical orientation to allow transportation of rake 10, particularly along roads.

FIG. 6 is a side perspective view of an embodiment of a rake 10 of the present invention attached to front end loader 90 and lifted off its wheels 24. Coupler 20 of rake 10 attaches to receiver 91. Lift cylinders 93 move lift arms upward, lifting rake 10 off of the ground. In FIG. 6, tine wheels 70 and their supporting elements are in a deployed configuration with the rake 10 fully lifted from the ground. The ability to lift rake 10 fully off of the ground allows a user to more easily align rake 10 at the end of fields, to enter and leave fields, and to negotiate disruptive features in and around fields, such as ditches and the like. Rake 10 may be simply lifted and repositioned as desired using the front end loader.

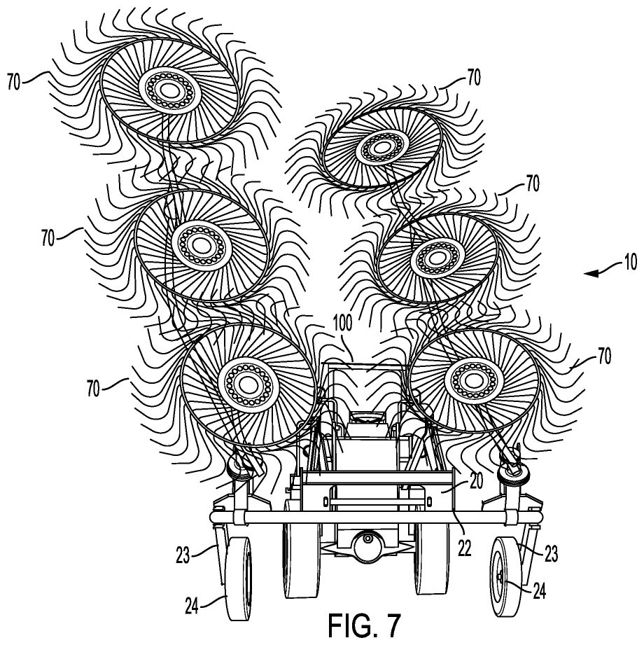

FIG. 7 is a front perspective view of an embodiment of rake 10 attached to front end loader 90 and with its tine wheels and support elements in an up position for transport. Rake 10 is shown with wheels 24 on the ground. However, as in FIG. 6, rake 10 could be completely lifted when rake 10 if configured as shown in FIG. 7. Boom mounts 30 are rotated upward and booms 40 are rotated upward as well to place the supports of the tine wheels a nearly vertical orientation. This arrangement gives rake 10 a narrower progile. In this configuration, rake 10 can be completely lifted and transported over more extensive distances, including over public right of ways having traffic. As may be seen in FIGS. 6 and 7, in particular, the compact configuration of rake 10 and its close joining with a front end loader, allows rake 10 to be lifted by the front end loader, greatly increasing the flexibility of use of rake 10. For embodiments of rake 10 having trail arms and wheels, the compactness of rake 10 places the wheels back near the front wheels of the carrying vehicle. This allows the carrying vehicle to turn on its normal turning radius, even when rake 10 is lowered and the wheels are in touch with the ground to support rake 10.

It is to be understood that the embodiments, and claims are not limited in application to the details of construction, and arrangement of the components set forth in the description and illustrated in the drawings. Rather, the description and the drawings provide examples of the embodiments envisioned, but the claims are not limited to any particular embodiment or a preferred embodiment disclosed and / or identified in the specification. The drawing figures are for illustrative purposes only, and merely provide practical examples of the invention disclosed herein. Therefore, the drawing figures should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

I claim:

1. A rake, comprising:
a coupler for connecting to a front end loader of a vehicle, the coupler having a back facing toward the vehicle and a front facing away from the vehicle when the coupler is attached to a front end loader;
a first boom mount on the coupler, the first boom mount defining a first axis, the first axis extending forward from the coupler and being substantially horizontal;
a first boom rotatably mounted to the first boom mount to rotate about the first axis, the first boom extending forward at an angle from the first axis and having a proximal end nearer to the coupler and a distal end further from the coupler;
a first support arm having a proximal end nearer to the coupler and a distal end further from the coupler, the first support arm being rotatably mounted to the first boom proximal to its proximal end and the proximal end of the first boom, the first support arm rotating about an axis that is substantially horizontal;
a first tine wheel rotatably mounted proximal to the distal end of the first support arm, the first tine wheel rotating about an axis that is substantially horizontal;
a first spar having a proximal end nearer the coupler and a distal end further from the coupler, the first spar being rotatably connected between its proximal and distal ends to the first boom proximal to the distal end of the first boom, the first spar rotating about an axis that is substantially horizontal;
a second tine wheel rotatably mounted to the first spar proximal to the proximal end of the first spar, the second tine wheel rotating about an axis that is substantially horizontal;
a third tine wheel rotatably mounted to the first spar proximal to the distal end of the first spar, the third tine wheel rotating about an axis that is substantially horizontal.

2. The rake of claim 1, wherein:
the first boom mount on the coupler is rotatably mounted to the coupler, the first boom mount rotating about an axis not aligned with the first axis.

3. The rake of claim 1, further comprising:
a second boom mount on the coupler, the second boom mount being horizontally spaced from the first boom mount and defining a second axis, the second axis extending forward from the coupler substantially parallel to the first axis;
a second boom rotatably mounted to the second boom mount to rotate about the second axis, the second boom extending forward at an angle opposite that of the first boom and having a proximal end nearer to the coupler and a distal end further from the coupler;
a second support arm having a proximal end nearer to the coupler and a distal end further from the coupler, the second support arm being rotatably mounted to the second boom proximal to its proximal end and the proximal end of the second boom, the second support arm rotating about an axis that is substantially horizontal;
a fourth tine wheel rotatably mounted proximal to the distal end of the second support arm, the fourth tine wheel rotating about an axis that is substantially horizontal;
a second spar having a proximal end nearer the coupler and a distal end further from the coupler, the second spar being rotatably connected between its proximal and distal ends to the second boom proximal to the distal end of the second boom, the second spar rotating about an axis that is substantially horizontal;
a fifth tine wheel rotatably mounted to the second spar proximal to the proximal end of the second spar, the fifth tine wheel rotating about an axis that is substantially horizontal;
a sixth tine wheel rotatably mounted to the second spar proximal to the distal end of the second spar, the sixth tine wheel rotating about an axis that is substantially horizontal.

4. The rake of claim 3, wherein:
the second boom mount on the coupler is rotatably mounted to the coupler, the second boom mount rotating about an axis not aligned with the second axis.

5. The rake of claim 1, further comprising:
a first trail arm operatively associated with the coupler, the first trail extending backward from the coupler; and,
a wheel rotatably mounted to the first trail arm.

6. The rake of claim 5, wherein:
the first trail arm is pivotably connected to the coupler.

7. The rake of claim 5, further comprising:
a second trail arm operatively associated with the coupler, the first trail extending backward from the coupler; and,
a wheel rotatably mounted to the second trail arm.

8. The rake of claim 7, wherein:
the second trail arm is pivotably connected to the coupler.

9. A rake in combination with a front end loader, comprising:
a front end loader configured to mount to a vehicle and comprising a receiver portion of an implement connector; and,
a rake, the rake comprising;
a coupler portion of an implement connector, the coupler and the receiver of the implement connector coupling to each other to attach the rake to the front end loader and the coupler having a back facing rearward toward vehicle and a front facing forward away from the vehicle;
a first boom mount on the coupler, the first boom mount defining a first axis, the first axis extending forward from the coupler and being substantially horizontal;
a first boom rotatably mounted to the first boom mount to rotate about the first axis, the first boom extending forward at an angle from the first axis and having a proximal end nearer to the coupler and a distal end further from the coupler;
a first support arm having a proximal end nearer to the coupler and a distal end further from the coupler, the first support arm being rotatably mounted to the first boom proximal to its proximal end and the proximal end of the first boom, the first support arm rotating about an axis that is substantially horizontal;
a first tine wheel rotatably mounted proximal to the distal end of the first support arm, the first tine wheel rotating about an axis that is substantially horizontal;
a first spar having a proximal end nearer the coupler and a distal end further from the coupler, the first spar being rotatably connected between its proximal and distal ends to the first boom proximal to the distal end of the first boom, the first spar rotating about an axis that is substantially horizontal;
a second tine wheel rotatably mounted to the first spar proximal to the proximal end of the first spar, the second tine wheel rotating about an axis that is substantially horizontal;
a third tine wheel rotatably mounted to the first spar proximal to the distal end of the first spar, the third tine wheel rotating about an axis that is substantially horizontal.

10. The rake in combination with a front end loader of claim 9, wherein:
the first boom mount on the coupler is rotatably mounted to the coupler, the first boom mount rotating about an axis not aligned with the first axis.

11. The rake in combination with a front end loader of claim 9, further comprising:
a second boom mount on the coupler, the second boom mount defining a second axis horizontally spaced from the first axis, the second axis extending forward from the coupler substantially parallel to the first axis;
a second boom rotatably mounted to the second boom mount to rotate about the second axis, the second boom extending forward at an angle opposite that of the first boom and having a proximal end nearer to the coupler and a distal end further from the coupler;
a second support arm having a proximal end nearer to the coupler and a distal end further from the coupler, the second support arm being rotatably mounted to the second boom proximal to its proximal end and the proximal end of the second boom, the second support arm rotating about an axis that is substantially horizontal;
a fourth tine wheel rotatably mounted proximal to the distal end of the second support arm, the fourth tine wheel rotating about an axis that is substantially horizontal;
a second spar having a proximal end nearer the coupler and a distal end further from the coupler, the second spar being rotatably connected between its proximal and distal ends to the second boom proximal to the distal end of the second boom, the second spar rotating about an axis that is substantially horizontal;
a fifth tine wheel rotatably mounted to the second spar proximal to the proximal end of the second spar, the fifth tine wheel rotating about an axis that is substantially horizontal;
a sixth tine wheel rotatably mounted to the second spar proximal to the distal end of the second spar, the sixth tine wheel rotating about an axis that is substantially horizontal.

12. The rake in combination with a front end loader of claim 11, wherein:
the second boom mount on the coupler is rotatably mounted to the coupler, the second boom mount rotating about an axis not aligned with the second axis.

13. The rake in combination with a front end loader of claim 9, further comprising:
a first trail arm operatively associated with the coupler, the first trail extending backward from the coupler; and,
a wheel rotatably mounted to the first trail arm.

14. The rake in combination with a front end loader of claim 13, wherein:
the first trail arm is pivotably connected to the coupler.

15. The rake in combination with a front end loader of claim 13, further comprising:
a second trail arm operatively associated with the coupler, the first trail arm extending backward from the coupler; and,
a wheel rotatably mounted to the second trail arm.

16. The rake in combination with a front end loader of claim 15, wherein:
the second trail arm is pivotably connected to the coupler.

17. A rake, comprising:
a coupler for connecting to a front end loader of a vehicle, the coupler having a back facing toward the vehicle and a front facing away from the vehicle when the coupler is attached to a front end loader;
a pair of boom mounts on the coupler, the boom mounts defining a pair of axes horizontally spaced from each other and extending forward from the coupler, the axes being substantially horizontal;
a first boom pivotably mounted to a first one of the boom mounts, the first boom pivoting about the respective axis and carrying a first set of tine wheels, each of the tine wheels in the first set of tine wheels turning about a different substantially horizontal axis;
a second boom pivotably mounted to the other one of the boom mounts, the second boom pivoting about the respective axis and carrying a second set of tine wheels, each of the tine wheels in the second set of tine wheels turning about a different substantially horizontal axis.

18. The rake of claim 17, further comprising:
a support arm pivotably mounted to each of the booms, each support arm carrying a first tine wheel of each of the set of tine wheels, each support arm pivoting on its respective boom about a substantially horizontal axis.

19. The rake of claim 17, further comprising:
a spar pivotably mounted to each of the booms, each spar arm carrying a second tine wheel and a third tine wheel of a respective set of tine wheels, each spar pivoting on its respective boom about a substantially horizontal axis.

20. The rake of claim 17, further comprising:
at least one trail arm extending back from the coupler; and,
a wheel mounted to the trail arm, the wheel mounted on a substantially horizontal axis.

21. The rake of claim 20, wherein:
at least one trail arm is pivotally attached to the coupler so as to pivot about a substantially vertical axis.
